(19) United States
(12) Patent Application Publication
(10) Pub. No.: US 2026/0323592 A1
(43) Pub. Date: Oct. 15, 2026

(54) USER PLANE CONNECTION ESTABLISHMENT METHOD AND APPARATUS, AND STORAGE MEDIUM

(71) Applicant: Beijing Xiaomi Mobile Software Co., Ltd., Beijing (CN)

(72) Inventors: Yubing GONG, Beijing (CN); Yuxin MAO, Beijing (CN); Yang SHEN, Beijing (CN); Xinli WANG, Beijing (CN)

(21) Appl. No.: 19/483,962

(22) PCT Filed: May 12, 2023
(86) PCT No.: PCT/CN2023/094065

§ 371 Date: Nov. 12, 2025

(51) Int. Cl. H04W 64/00; H04W 36/00; H04W 36/32; H04W 76/19

(52) U.S. Cl. CPC H04W 64/006; H04W 36/0055; H04W 36/324; H04W 76/19

(57) ABSTRACT

A method for establishing a user plane connection is performed by an access and mobility management function (AMF) and includes: determining a target location management function (LMF) for user plane positioning in response to determining that a first device triggers reselection of an LMF, where the first device includes at least one of a terminal, the AMF, a source LMF, or a session management function (SMF); and sending information on the target LMF to the SMF, where the information on the target LMF is configured to instruct the SMF to establish a user plane connection between the terminal and the target LMF. terminal,

### CROSS REFERENCE TO RELATED APPLICATION

The present application is a U.S. National Stage of International Application No. PCT/CN2023/094065, filed on May 12, 2023, the entire contents of which are incorporated herein by reference.

### BACKGROUND OF THE INVENTION

Currently, a user plane connection may be established between a terminal and a Location Management Function (LMF). The user plane connection is independent of connections between other network elements in a 5th Generation Mobile Communication Technology (5G) system, and the 5G system may have a more efficient communication load by user plane positioning. A single session may handle a plurality of transactions, and may support a plurality of positioning modes.

### SUMMARY OF THE INVENTION

According to a first aspect of the embodiments of the present disclosure, a method for establishing a user plane connection is provided. The method is performed by an Access and Mobility Management Function (AMF), including:
determining a target LMF for user plane positioning in response to determining that a first device triggers reselection of an LMF, where the first device includes at least one of a terminal, the AMF, a source LMF, or a Session Management Function (SMF); and
sending information on the target LMF to the SMF, where the information on the target LMF is configured to instruct the SMF to establish a user plane connection between the terminal and the target LMF.

According to a second aspect of the embodiments of the present disclosure, a method for establishing a user plane connection is provided. The method is performed by an SMF, including:
receiving information on a target LMF sent by an AMF, where the information on the target LMF is sent to the SMF after the AMF determines that a first device triggers reselection of an LMF and the AMF determines the target LMF, and the first device includes at least one of a terminal, the AMF, a source LMF, or the SMF; and
establishing a user plane connection between the terminal and the target LMF based on the information on the target LMF.

According to a third aspect of the embodiments of the present disclosure, a method for establishing a user plane connection is provided. The method is performed by a terminal, including:
sending a first message to an AMF in response to determining that reselection of an LMF needs to be triggered, where the first message includes a reason for re-establishing a user plane connection between the terminal and the LMF, or the first message indicates the reason for re-establishing the user plane connection.

According to a fourth aspect of the embodiments of the present disclosure, a device for establishing a user plane connection is provided. The device is applied to an AMF, and includes a processor and a memory configured to store processor-executable instructions. The processor is configured to perform the method for establishing the user plane connection in the first aspect.

According to a fifth aspect of the embodiments of the present disclosure, a device for establishing a user plane connection is provided. The device is applied to an SMF, and includes a processor and a memory configured to store processor-executable instructions. The processor is configured to perform the method for establishing the user plane connection in the second aspect.

According to a sixth aspect of the embodiments of the present disclosure, a device for establishing a user plane connection is provided. The device is applied to a terminal, and includes a processor and a memory configured to store processor-executable instructions. The processor is configured to perform the method for establishing the user plane connection in the third aspect.

### BRIEF DESCRIPTION OF DRAWINGS

Accompanying drawings here are incorporated into the specification, constitute a part of the specification, show embodiments conforming to the present disclosure, and are used to explain the principle of the present disclosure together with the specification.

FIG. 1 is a schematic flowchart of a method for establishing a user plane connection according to an example.

FIG. 2 is a schematic flowchart of a method for establishing a user plane connection according to another example.

FIG. 3 is a schematic flowchart of a method for establishing a user plane connection according to another example.

FIG. 4 is a schematic flowchart of a method for establishing a user plane connection according to another example.

FIG. 5 is a schematic flowchart of a method for establishing a user plane connection according to another example.

FIG. 6 is a schematic flowchart of a method for establishing a user plane connection according to another example.

FIG. 7 is a schematic flowchart of a method for establishing a user plane connection according to another example.

FIG. 8 is a block diagram of a device for establishing a user plane connection according to an example.

FIG. 9 is a block diagram of a device for establishing a user plane connection according to another example.

FIG. 10 is a block diagram of a device for establishing a user plane connection according to another example.

FIG. 11 is a block diagram of a system for establishing a user plane connection according to an example.

FIG. 12 is a schematic diagram of a structure of a device for establishing a user plane connection according to an example in the present disclosure.

FIG. 13 is a schematic diagram of a structure of a device for establishing a user plane connection according to another example in the present disclosure.

### DETAILED DESCRIPTION OF THE INVENTION

Examples are illustrated in detail here, and their instances are shown in the accompanying drawings. When the following description refers to the accompanying drawings, unless otherwise indicated, the same numbers in different accompanying drawings indicate the same or similar elements. Implementations described in the following examples do not represent all implementations consistent with the present disclosure. Rather, they are merely instances of devices and methods consistent with some aspects of the present disclosure as detailed in the appended claims.

Terms used in the present disclosure are merely for the purpose of describing specific embodiments, and not intended to limit the present disclosure. “One,” “said,” and “the” of singular forms used in the present disclosure and the appended claims are also intended to include plural forms unless the context clearly indicates other meanings. It is also to be understood that the term “and/or” as used herein refers to and includes any or all possible combinations of at least one associated listed item.

It is to be understood that although the terms “first,” “second,” “third,” etc. may be used to describe various types of information in the present disclosure, such information is not to be limited to these terms. These terms are merely used to distinguish the same type of information from each other. For example, without departing from the scope of the present disclosure, a first message may also be referred to as a second message, and similarly, the second message may also be referred to as the first message. Depending on the context, for example, words “in a case where” as used here may be interpreted as “at the time of,” “when,” or “in response to determining.”

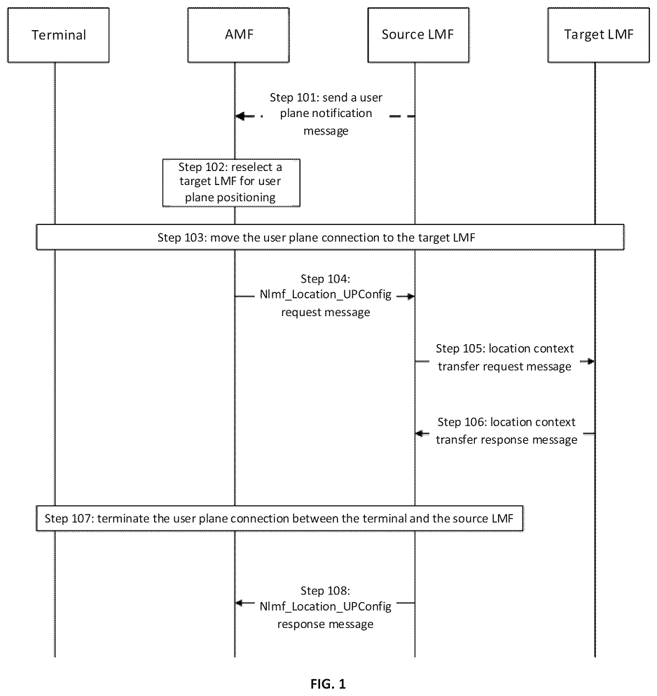

An embodiment of the present disclosure provides a method for establishing a user plane connection. As shown with reference to FIG. 1, which is a flowchart of a method for establishing a user plane connection according to an embodiment, the method may include the following steps 101 to 108.

In step 101, a source LMF determines that reselection of an LMF needs to be performed, and the source LMF sends a user plane notification (Nlmf_Location_UPNotify) message that includes user plane information and indicates a reason for modification.

An address of an AMF is provided to the source LMF as a notification target address in a user plane configuration (Nlmf_Location_UPConfig) message or the NImf_Location_UPNotify message.

In step 102, the AMF needs to reselect a target LMF for user plane positioning.

The LMF needs to be capable of establishing a user plane connection for positioning with a terminal. In addition, in a case of AMF relocation, i.e., a change in the AMF, a relocated target AMF needs to notify the LMF of the change in the AMF, such that the LMF determines the changed target AMF.

In step 103, the user plane connection is moved to the target LMF.

In a case where AMF reallocation already occurs, step 103 is skipped. Otherwise, steps 103 to 108 are performed among the AMF, the terminal, and the target LMF. In addition, the terminal also needs to terminate a connection with the source LMF.

Steps 101, 102, and 103 above are optional execution steps.

In step 104, the AMF sends an NImf_Location_UPConfig request message to the source LMF.

The NImf_Location_UPConfig message may include a request for the source LMF to terminate a specific user plane connection with the terminal and for the target LMF. Alternatively, the NImf_Location_UPConfig message may include information about the AMF reallocation.

In step 105, in a case where a periodic and triggered terminal location event report context exists, the source LMF may invoke a location context transfer request (Nlmf_Location_LocationContextTransfer Request) service operation towards the target LMF to provide a current location context of UE.

In step 106, the target LMF notifies the source LMF of a result of a location context transfer service operation.

In step 107, in a case where the user plane connection between the terminal and the source LMF is still in an active status, the source LMF terminates the connection with the terminal.

In step 108, the LMF sends an NImf_Location_UPConfig response message to the AMF to confirm the termination of the connection or to acknowledge the change of the AMF.

In the above embodiment, the reselection of the LMF may be triggered by the source LMF, thus a new user plane connection may be established between the terminal and the target LMF, and the availability is high.

However, in the above embodiment, the following problems exist.
Problem I. Possible trigger factors for the reselection of the LMF are lost.

That is, in the above embodiment, the reselection of the LMF is triggered merely based on the source LMF. But in practical applications, other network elements or terminals may also trigger the reselection of the LMF, and thus cases of the reselection of the LMF by network elements other than the source LMF are not considered in the above embodiment.
Problem II. There is a lack of consideration of possible influences on an SMF and a User Plane Function (UPF).

The LMF is in a user plane connection with the UE through the UPF selected by the SMF. In a case where the LMF is changed, the UPF connected to the LMF may also be influenced. Possible influences on the SMF and the UPF are not considered in the above embodiment.

Thus, the present disclosure further provides a method and device for establishing a user plane connection, and a storage medium. At least one of the terminal, the AMF, the source LMF, or the SMF may trigger the reselection of the LMF, and possible influences caused by the reselection of the LMF on the SMF and the UPF are taken into consideration. The reliability of the established user plane connection is improved, and the availability is high.

The method for establishing the user plane connection provided by the present disclosure is first introduced below from an AMF side.

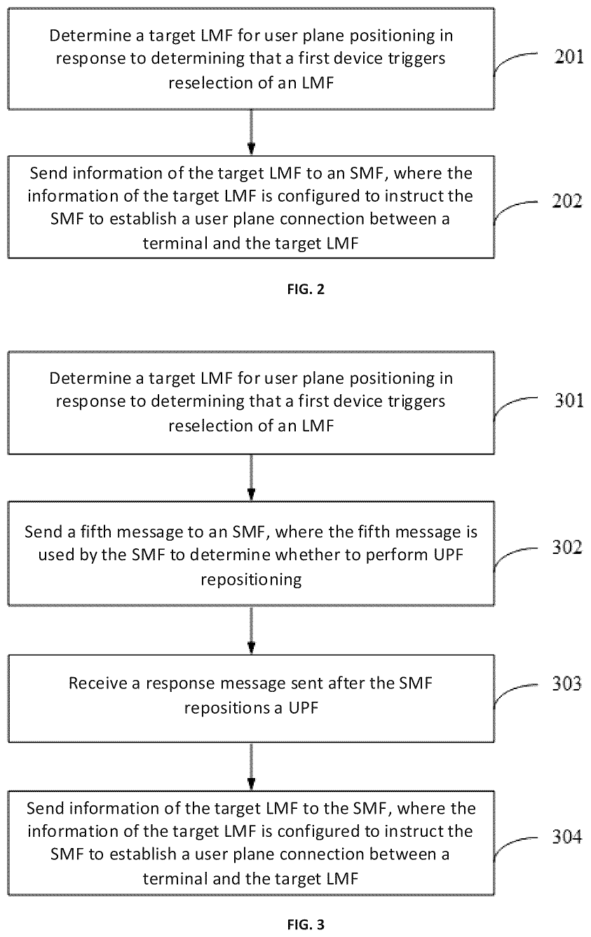

An embodiment of the present disclosure provides a method for establishing a user plane connection. As shown with reference to FIG. 2, which is a flowchart of a method for establishing a user plane connection according to an embodiment, the method may be performed by an AMF and may include the following steps 201 and 202.

In step 201, a target LMF for user plane positioning is determined in response to determining that a first device triggers reselection of an LMF.

It is to be noted that the method for establishing the connection provided by the embodiment of the present disclosure presupposes that a terminal has successfully established a user plane connection with a source LMF. The source LMF refers to an LMF that provides a location service to the terminal before the reselection of the LMF. It is to be understood that after the reselection of the LMF, the LMF that serves the terminal is switched from the source LMF to the target LMF.

In the embodiment of the present disclosure, the first device includes, but is not limited to, at least one of the following: the terminal, the AMF, the source LMF, or an SMF.

In a possible implementation, the first device may be the source LMF. In a case where the source LMF finds a need to change the LMF or re-establish a user plane connection between the UE and the LMF, the source LMF sends an NImf_Location_UPNotify message, which includes user plane information and indicates a reason for modification, to the AMF. At this point, the AMF determines that the source LMF triggers the reselection of the LMF.

In another possible implementation, the first device may be the terminal. The AMF determines that the terminal triggers the reselection of the LMF in a case of receiving a first message sent by the terminal.

In one example, the first message may include or indicate a reason for re-establishing the user plane connection.

For example, the reason may be terminal mobility or other reasons, which is not limited in the present disclosure.

For example, the first message includes the reason, e.g., the first message includes the terminal mobility.

For example, the reason may be indicated in the first message, e.g., an information field is set in the first message, and different reasons may be indicated according to values of the information field. In a possible embodiment, in a case where a bit value of the information field is set to 1, it is configured to indicate that the reason is the terminal mobility. It is to be understood that other bit values and their corresponding reasons are also possible.

In one example, the first message may include first user plane information. The first user plane information includes information on the source LMF. The information on the source LMF includes, but is not limited to, at least one of the following: an Internet Protocol (IP) address of the source LMF, a Fully Qualified Domain Name (FQDN) of the source LMF, an identifier of the source LMF (e.g., a physical address of the source LMF), or a service area of the source LMF, etc.

In one example, the first message may include, but is not limited to, adoption of an uplink non-access stratum transport (UL NAS TRANSPORT) message, or the first message may adopt a service request message, which is not limited in the present disclosure.

In another possible implementation, the first device may be the SMF. The AMF determines that the SMF triggers the reselection of the LMF in a case of receiving a second message sent by the SMF. The second message may be configured to indicate a change related to a Protocol Data Unit (PDU) session.

In one example, the second message may be configured to indicate a change in the UPF connected with the source LMF.

In one example, the AMF may subscribe to a PDU session management context status notification (Nsmf_PDUSession_SMContextStatusNotify) service of the SMF before receiving the second message.

Certainly, the AMF may not subscribe to the Nsmf_PDUSession_SMContextStatusNotify service, which is not limited in the present disclosure.

In another possible implementation, the first device may be the AMF itself, i.e., the AMF may trigger the reselection of the LMF by itself.

In one example, in response to determining that a status of the terminal changes, it is determined that the AMF triggers the reselection of the LMF.

In the embodiment of the present disclosure, information related to a movement trajectory of the terminal may be prerecorded on the AMF. The AMF determines, based on the information, that the status of the terminal changes or the terminal moves, etc., and may determine to trigger the reselection of the LMF.

In another example, the AMF may determine, based on a third message sent by the SMF, to trigger the reselection of the LMF.

For example, the third message may include, but is not limited to, at least one of information on the UPF or information related to the LMF. The AMF determines, based on at least one of the information on the UPF or the information related to the LMF in the third message, to trigger the reselection of the LMF.

In another example, the AMF may determine, based on a fourth message sent by the terminal, to trigger the reselection of the LMF.

For example, the fourth message may include mobility information on the terminal.

In one possible implementation, the reselection of the LMF includes, but is not limited to, releasing a user plane connection between the terminal and the source LMF, and establishing the user plane connection between the terminal and the target LMF.

In the embodiment of the present disclosure, in a case of determining that the first device triggers the reselection of the LMF, the AMF may determine the target LMF for the terminal based on information such as a serving cell where the terminal is located, and a terminal location. The target LMF is an LMF determined to provide a location service to the terminal after the AMF reselects the LMF.

In step 202, information on the target LMF is sent to the SMF. The information on the target LMF is configured to instruct the SMF to establish the user plane connection between the terminal and the target LMF.

For example, the information on the target LMF includes, but is not limited to, at least one of the following: an IP address of the target LMF; an FQDN of the target LMF; an identifier of the target LMF; or a service area of the target LMF, etc.

The identifier of the target LMF may be information that may uniquely identify the target LMF, such as a physical address of the target LMF, which is not limited in the present disclosure.

In the embodiment of the present disclosure, the PDU session is already established when the terminal establishes the user plane connection with the source LMF. In the present disclosure, after determining the target LMF, the AMF may send the information on the target LMF to the SMF, such that the SMF establishes the user plane connection between the terminal and the target LMF based on the information on the target LMF.

In the embodiment of the present disclosure, for the SMF, in a case where PDU Session Anchor User Plane Function (PSA UPF) relocation is triggered based on a Session and Service Continuity (SSC) mode 2 or mode 3, the SMF establishes the user plane connection between the terminal and the target LMF through a relocated UPF.

In a case where the SMF determines not to perform UPF relocation, the SMF establishes the user plane connection between the terminal and the target LMF through a previous UPF.

The SSC mode 2 and mode 3 may include releasing the user plane connection between the terminal and the source LMF, and establishing a new user plane connection between the terminal and the target LMF. In the present disclosure, there is no limitation on an order of the release of the user plane connection between the terminal and the source LMF and the establishment of the new user plane connection between the terminal and the target LMF. Correspondingly, the solution of the present disclosure supports the SSC mode 2 and mode 3.

In the above embodiment, the reselection of the LMF may be triggered by at least one of the terminal, the AMF, the source LMF, or the SMF, expanding triggering factors that may trigger the reselection of the LMF, and the availability is high.

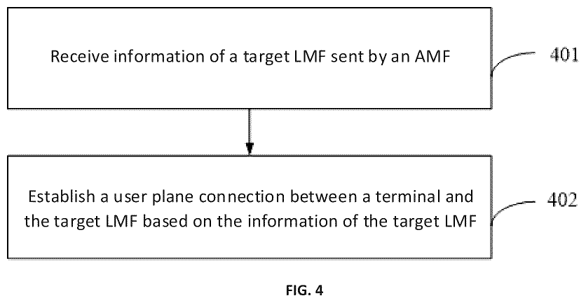

In some embodiments, as shown with reference to FIG. 3, which is a flowchart of a method for establishing a user plane connection according to an embodiment, the method may be performed by an AMF, and may include the following steps 301 to 304.

In step 301, a target LMF for user plane positioning is determined in response to determining that a first device triggers reselection of an LMF.

In the embodiment of the present disclosure, the first device includes, but is not limited to, at least one of the following: a terminal, the AMF, a source LMF, or an SMF.

An implementation of step 301 is similar to that of the above step 201, which is not repeated here.

In step 302, a fifth message is sent to the SMF. The fifth message is used by the SMF to determine whether to perform UPF relocation.

In the embodiment of the present disclosure, the fifth message may be a PDU session update session management context request (Nsmf_PDUSession_Update_SMContext Request) message.

Alternatively, in a case where the SMF subscribes to a status notification of the LMF on the AMF, the fifth message may be a notification message. The notification message is configured to notify the SMF of a status change of the LMF. For example, the notification message may be an AMF status change notification (Namf_Communication_AMFStatusChangeNotify) message.

For example, the AMF may send an AMF status change subscription request (Namf_Communication_AMFStatusChangeSubscribe) message to the SMF before sending the notification message. In a case where the SMF agrees with subscription, the AMF receives an AMF status change subscription response (Namf_Communication_AMFStatusChangeSubscribe) message sent by the SMF. Correspondingly, the AMF may send the Namf_Communication_AMFStatusChangeNotify message to the SMF after determining the target LMF, such that the SMF determines whether UPF relocation needs to be performed. The Namf_Communication_AMFStatusChangeNotify message includes information on the target LMF, i.e., the information on the target LMF is added to the Namf_Communication_AMFStatusChangeNotify message as a new parameter.

In one example, the fifth message may be configured to notify the SMF of at least one of the following: a change in an LMF used to establish a user plane connection with the terminal; or the information on the target LMF.

The information on the target LMF includes, but is not limited to, at least one of an IP address of the target LMF, an FQDN of the target LMF, an identifier of the target LMF, or a service area of the target LMF.

In one example, the AMF may also trigger an insertion or relocation process of an Intermediate Session Management Function (I-SMF) based on the information on the target LMF.

It is to be noted that after receiving the fifth message, the SMF may determine that any of the following cases exists.
Case 1. There is a change in the SMF and possibly a change in the UPF.
Case 2. The SMF is unchanged, and there is a change in the UPF.
Case 3. Neither the SMF nor the UPF needs to be changed.

In step 303, a response message sent by the SMF after the SMF relocates the UPF is received.

In the embodiment of the present disclosure, step 303 is an optional execution step, i.e., the response message is received by the AMF merely in a case where the SMF determines to perform UPF relocation.

In one example, the response message may be a PDU session update management context response (Nsmf_PDUSession_Update_SMContext Response) message.

In the embodiment of the present disclosure, there may be a plurality of UPFs relocated by the SMF, including, but not limited to, at least one of the following: a branching point, an Uplink Classifier (UL CL), or a PSA UPF.

In step 304, the information on the target LMF is sent to the SMF. The information on the target LMF is configured to instruct the SMF to establish the user plane connection between the terminal and the target LMF.

An implementation of step 304 is similar to that of the above step 202, which is not repeated here.

In the above embodiment, possible influences caused by the reselection of the LMF on the SMF and the UPF are taken into consideration. The reliability of the established user plane connection is improved, and the availability is high.

A method for establishing a user plane connection provided by the present disclosure is further introduced below from an SMF side.

An embodiment of the present disclosure provides a method for establishing a user plane connection. As shown with reference to FIG. 4, which is a flowchart of a method for establishing a user plane connection according to an embodiment, the method may be performed by an SMF and may include the following steps 401 and 402.

In step 401, information on a target LMF sent by an AMF is received.

In the embodiment of the present disclosure, the information on the target LMF is sent to the SMF after the AMF determines that a first device triggers reselection of an LMF and the AMF determines the target LMF. The first device includes at least one of a terminal, the AMF, a source LMF, or the SMF.

It is to be noted that the reselection of the LMF may be triggered by the SMF. Specifically, the SMF sends a second message to the AMF in response to determining that the reselection of the LMF needs to be triggered. The second message is configured to indicate a change related to a PDU session.

In one example, the second message may be configured to indicate a change in the UPF connected with the source LMF.

In one example, the AMF may subscribe to a PDU session management context status notification (Nsmf_PDUSession_SMContextStatusNotify) service of the SMF before receiving the second message. The Nsmf_PDUSession_SMContextStatusNotify message may include information related to the target LMF.

Certainly, the AMF may not subscribe to the Nsmf_PDUSession_SMContextStatusNotify service, which is not limited in the present disclosure.

In one possible implementation, the information on the target LMF includes, but is not limited to, at least one of the following: an IP address of the target LMF; an FQDN of the target LMF; an identifier of the target LMF; or a service area of the target LMF.

In step 402, a user plane connection is established between the terminal and the target LMF based on the information on the target LMF.

In the embodiment of the present disclosure, the AMF may establish the user plane connection between the terminal and the target LMF based on the information on the target LMF.

In the above embodiment, the SMF may be taken as a factor triggering the reselection of the LMF, expanding triggering factors that may trigger the reselection of the LMF, and the availability is high.

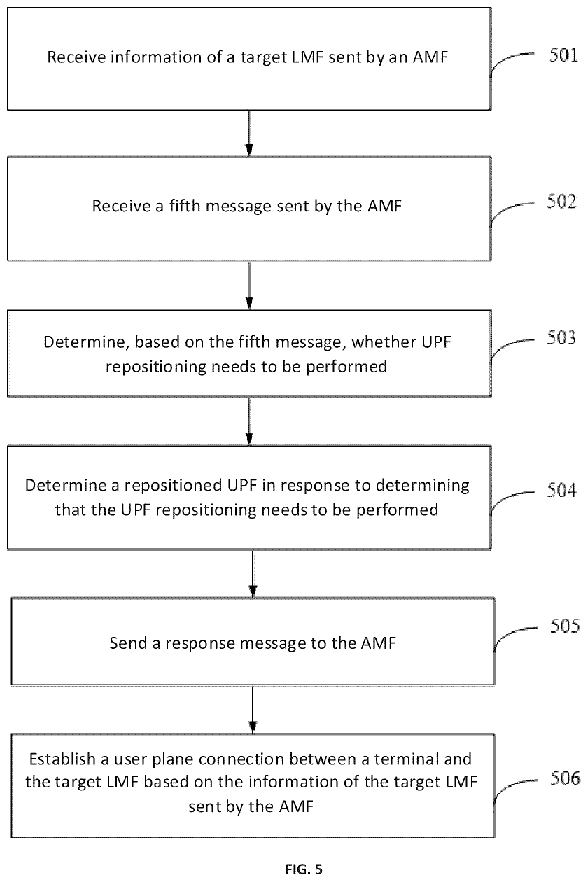

In some embodiments, as shown with reference to FIG. 5, which is a flowchart of a method for establishing a user plane connection according to an embodiment, the method may be performed by an SMF and may include the following steps 501 to 506.

In step 501, information on a target LMF sent by an AMF is received.

An implementation of step 501 is similar to that of the above step 401, which is not repeated here.

In step 502, a fifth message sent by the AMF is received.

In one possible implementation, the fifth message includes a PDU session update session management context request (Nsmf_PDUSession_Update_SMContext request) message.

In another possible implementation, in a case where the SMF subscribes to a status notification of an LMF, the fifth message may include a notification message. The notification message includes the information on the target LMF and is configured to notify the SMF of a status change of the LMF.

For example, the notification message may be an AMF status change notification (Namf_Communication_AMFStatusChangeNotify) message.

For example, the SMF may receive an AMF status change subscription request (Namf_Communication_AMFStatusChangeSubscribe) message sent by the AMF before receiving the notification message. In a case where the SMF agrees with subscription, the SMF sends an AMF status change subscription response (Namf_Communication_AMFStatusChangeSubscribe) message to the AMF. Correspondingly, after the AMF determines the target LMF, the SMF may receive the Namf_Communication_AMFStatusChangeNotify message sent by the AMF, such that the SMF determines whether UPF relocation needs to be performed. The Namf_Communication_AMFStatusChangeNotify message may include the information on the target LMF.

In one example, the fifth message may be configured to notify the SMF of at least one of the following: a change in an LMF used to establish a user plane connection with the terminal; or the information on the target LMF.

The information on the target LMF includes, but is not limited to, at least one of an IP address of the target LMF, an FQDN of the target LMF, an identifier of the target LMF, or a service area of the target LMF.

In step 503, whether UPF relocation needs to be performed is determined based on the fifth message.

After receiving the fifth message, the SMF may determine that any of the following cases exists.
Case 1. There is a change in the SMF and possibly a change in the UPF.
Case 2. The SMF is unchanged, and there is a change in the UPF.
Case 3. Neither the SMF nor the UPF needs to be changed.

In step 504, a relocated UPF is determined in response to determining that the UPF relocation needs to be performed.

Step 504 and subsequent step 505 are optional execution steps. The SMF may determine the relocated UPF in a case of determining that the UPF relocation needs to be performed.

In the embodiment of the present disclosure, there may be a plurality of relocated UPFs, including, but not limited to, at least one of the following: a branching point, a UL CL, or a PSA UPF.

In step 505, a response message is sent to the AMF.

The response message is configured to inform the AMF that the SMF performs the UPF relocation.

In one example, the response message may be a PDU session update session management context response (Nsmf_PDUSession_Update_SMContext Response) message.

In step 506, a user plane connection is established between the terminal and the target LMF based on the information on the target LMF sent by the AMF.

In one possible implementation, the SMF performs the UPF relocation, and then the SMF establishes the user plane connection between the terminal and the target LMF through the relocated UPF.

In another possible implementation, the SMF does not perform the UPF relocation, and then the SMF establishes the user plane connection between the terminal and the target LMF through a previous UPF.

In the embodiment of the present disclosure, the reselection of the LMF includes releasing a user plane connection between the terminal and the source LMF, and establishing the user plane connection between the terminal and the target LMF.

For the SMF, in a case where PSA UPF relocation is triggered based on an SSC mode 2 or mode 3, the SMF establishes the user plane connection between the terminal and the target LMF through the relocated UPF. The SSC mode 2 and mode 3 may include releasing the user plane connection between the terminal and the source LMF, and establishing a new user plane connection between the terminal and the target LMF. In the present disclosure, there is no limitation on an order of the release of the user plane connection between the terminal and the source LMF and the establishment of the new user plane connection between the terminal and the target LMF. Correspondingly, the solution of the present disclosure supports the SSC mode 2 and mode 3.

In the above embodiment, possible influences caused by the reselection of the LMF on the SMF and the UPF are taken into consideration. The reliability of the established user plane connection is improved, and the availability is high.

A method for establishing a user plane connection provided by the present disclosure is further introduced below from a terminal side.

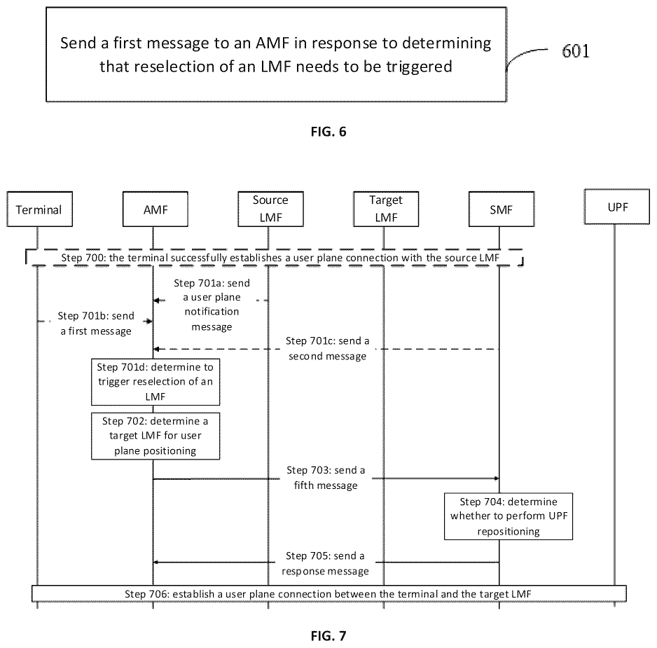

An embodiment of the present disclosure provides a method for establishing a user plane connection. As shown with reference to FIG. 6, which is a flowchart of a method for establishing a user plane connection according to an embodiment, the method may be performed by a terminal and may include the following step 601.

In step 601, a first message is sent to an AMF in response to determining that reselection of an LMF needs to be triggered.

In one example, the first message includes a reason for re-establishing a user plane connection between the terminal and the LMF.

In another example, the first message may indicate the reason for re-establishing the user plane connection.

For example, the reason may be terminal mobility or other reasons, which is not limited in the present disclosure.

For example, the first message includes the reason, e.g., the first message includes UE mobility.

For example, the reason may be indicated in the first message, e.g., an information field is set in the first message, and different reasons may be indicated according to values of the information field. In a possible embodiment, in a case where a bit value of the information field is set to 1, it is configured to indicate that the reason is the terminal mobility. It is to be understood that other bit values and their corresponding reasons are also possible.

In one example, the first message may include first user plane information. The first user plane information includes information on a source LMF. The information on the source LMF includes, but is not limited to, at least one of the following: an IP address of the source LMF, an FQDN of the source LMF, an identifier of the source LMF, or a service area of the source LMF, etc.

In one example, the first message may include, but is not limited to, adoption of a UL NAS TRANSPORT message, or the first message may adopt a service request message, which is not limited in the present disclosure.

In one example, the reselection of the LMF includes releasing a user plane connection between the terminal and the source LMF, and establishing a user plane connection between the terminal and a target LMF.

In the above embodiment, the terminal may be taken as a factor triggering the reselection of the LMF, expanding triggering factors that may trigger the reselection of the LMF, and the availability is high.

Further examples of the above solution are described below.

As shown with reference to FIG. 7, which is a flowchart of a method for establishing a user plane connection according to an embodiment, the method includes the following steps 700 to 706.

In step 700, a terminal successfully establishes a user plane connection with a source LMF.

In step 701a, the source LMF determines that reselection of an LMF needs to be triggered, and the source LMF sends a user plane update notification (Nlmf_Location_UPNotify) message that includes user plane information and indicates a reason for modification to an AMF.

At this point, the user plane information includes information related to the source LMF.

An implementation of step 701a is similar to that of the above step 101, which is not repeated here.

In step 701b, the terminal determines that the reselection of the LMF needs to be triggered and sends a first message to the AMF. The first message includes a reason for re-establishing a user plane connection, or, the first message indicates the reason for re-establishing the user plane connection.

An implementation of step 701b is similar to that of the above step 601, which is not repeated here.

In step 701c, an SMF determines that the reselection of the LMF needs to be triggered and sends a second message to the AMF. The second message is configured to indicate a change related to a PDU session.

An implementation of step 701c is similar to that of the above step 401 where the SMF sends the second message to the AMF, which is not repeated here.

In step 701d, the AMF determines to trigger the reselection of the LMF.

The implementation is similar to that of the above step 201 where the AMF determines to trigger the reselection of the LMF, which is not repeated here.

In the embodiment of the present disclosure, one of the above steps 701a to 701d may be selected to be performed.

In step 702, the AMF determines a target LMF for user plane positioning.

In step 703, the AMF sends a fifth message to the SMF. The fifth message is used by the SMF to determine whether to perform UPF relocation.

An implementation of step 703 is similar to that of the above step 302, which is not repeated here.

In step 704, the SMF determines, based on the fifth message, whether the UPF relocation needs to be performed.

An implementation of step 704 is similar to that of the above step 503, which is not repeated here.

In step 705, the SMF sends a response message to the AMF after performing the UPF relocation.

An implementation of step 705 is similar to that of the above steps 504 and 505, which is not repeated here.

In step 706, the SMF establishes the user plane connection between the terminal and the target LMF based on information on the target LMF sent by the AMF.

An implementation of step 706 is similar to that of the above step 506, which is not repeated here.

In one example, after step 706, steps 103 to 108 may be continuously performed.

In the above embodiment, at least one of the terminal, the AMF, the source LMF, or the SMF may trigger the reselection of the LMF, and possible influences caused by the reselection of the LMF on the SMF and the UPF are taken into consideration. The reliability of the established user plane connection is improved, and the availability is high.

It is to be understood that the process of the above method for establishing the user plane connection provided by the present disclosure may be written in a process of a LoCation Service (LCS) of the 3rd Generation Partnership Project (3GPP), and may also be applied to a process of Ranging based services and Sidelink Positioning (Ranging_SL). Certainly, the process may be written in or applied to other processes, which is not limited in the present disclosure.

Corresponding to the foregoing method embodiments implemented by application functions, the present disclosure further provides device embodiments implemented by the application functions.

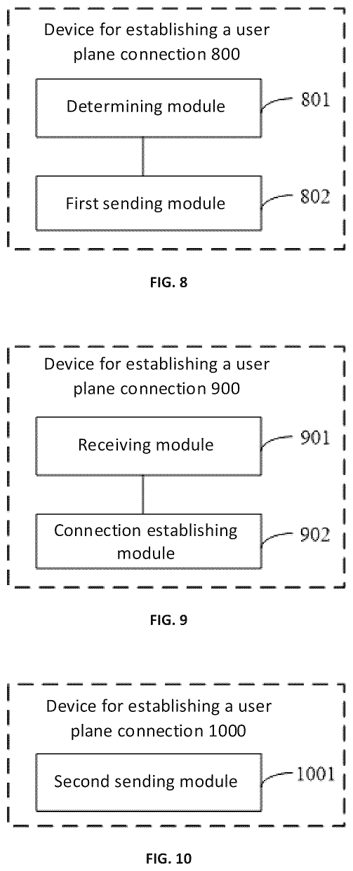

Referring to FIG. 8, which is a block diagram of a device 800 for establishing a user plane connection according to an example, the device 800 is applied to an AMF, and includes a determining module 801 and a first sending module 802.

The determining module 801 is configured to determine a target LMF for user plane positioning in response to determining that a first device triggers reselection of an LMF. The first device includes at least one of a terminal, the AMF, a source LMF, or an SMF.

The first sending module 802 is configured to send information on the target LMF to the SMF. The information on the target LMF is configured to instruct the SMF to establish a user plane connection between the terminal and the target LMF.

Referring to FIG. 9, which is a block diagram of a device 900 for establishing a user plane connection according to an example, the device 900 is applied to an SMF, and includes a receiving module 901 and a connection establishing module 902.

The receiving module 901 is configured to receive information on a target LMF sent by an AMF. The information on the target LMF is sent to the SMF after the AMF determines that a first device triggers reselection of an LMF and the AMF determines the target LMF. The first device includes at least one of a terminal, the AMF, a source LMF, or the SMF.

The connection establishing module 902 is configured to establish a user plane connection between the terminal and the target LMF based on the information on the target LMF.

Referring to FIG. 10, which is a block diagram of a device 1000 for establishing a user plane connection according to an example, the device 1000 is applied to a terminal, and includes a second sending module 1001.

The second sending module 1001 is configured to send a first message to an AMF in response to determining that reselection of an LMF needs to be triggered. The first message includes a reason for re-establishing a user plane connection between the terminal and the LMF, or the first message indicates the reason for re-establishing the user plane connection.

As for the device embodiments, as they basically correspond to the method embodiments, please refer to part of the descriptions of the method embodiments for related parts. The device embodiments described above are merely illustrative. Units described above as separate components may or may not be physically separated, and components displayed as units may or may not be physical units, that is, they may be located in one place, or they may be distributed onto a plurality of network units. Some or all of the modules may be selected according to actual needs to implement the objective of the scheme of the present disclosure. Those of ordinary skill in the art may understand and implement it without creative work.

Correspondingly, the present disclosure further provides a computer-readable storage medium storing a computer program. The computer program is configured to implement the method for establishing the user plane connection described in any one of the above.

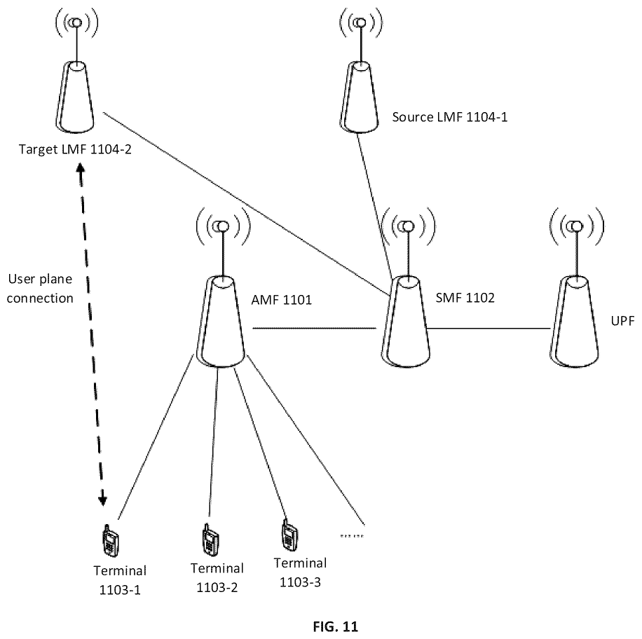

Correspondingly, the present disclosure further provides a system for establishing a user plane connection. With reference to FIG. 11, the system may include an AMF 1101, an SMF 1102, a terminal 1103, and an LMF 1104.

The AMF 1101 is configured to perform the method for establishing the user plane connection described in any one of the above on the AMF side.

The SMF 1102 is configured to perform the method for establishing the user plane connection described in any one of the above on the SMF side.

The terminal 1103 is configured to perform the method for establishing the user plane connection described in any one of the above on the terminal side.

The LMF 1104 is used to establish a user plane connection with the terminal.

There are a plurality of terminals in FIG. 11. The LMF 1104 may specifically include a source LMF 1104-1 and a target LMF 1104-2.

The system may further include a UPF.

Correspondingly, the present disclosure further provides a device for establishing a user plane connection, including:
a processor; and
a memory configured to store processor-executable instructions.

The processor is configured to perform the method for establishing the user plane connection described in any one of the above on an access network element side.

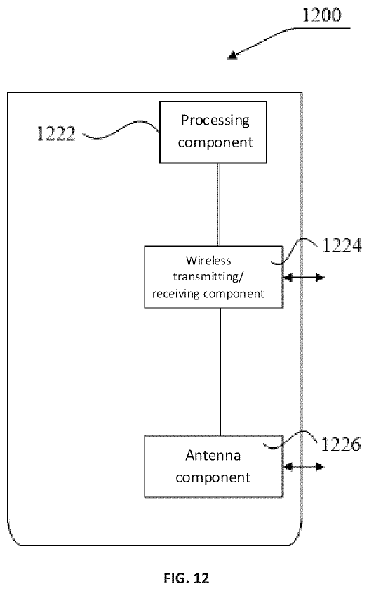

As shown in FIG. 12, FIG. 12 is a schematic diagram of a structure of a device 1200 for establishing a user plane connection according to an example. The device 1200 may be provided as an access network element, including, but not limited to, an AMF, an SMF, a source LMF, etc. Referring to FIG. 12, the device 1200 includes a processing component 1222, a wireless transmitting/receiving component 1224, an antenna component 1226, and a signal processing part specific to a wireless interface. The processing component 1222 may further include at least one processor.

One processor in the processing component 1222 may be configured to perform the method for establishing the user plane connection described in any one of the above on the AMF, SMF, and source LMF sides.

Correspondingly, the present disclosure further provides a device for establishing a user plane connection, including:
a processor; and
a memory configured to store processor-executable instructions.

The processor is configured to perform the method for establishing the user plane connection described in any one of the above on the terminal side.

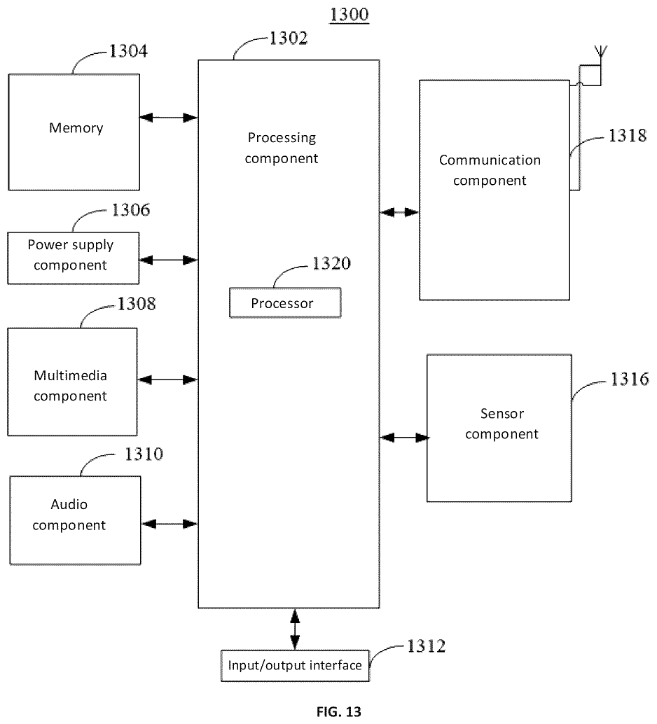

FIG. 13 is a block diagram of an electronic device 1300 according to an example. For example, the electronic device 1300 may be a terminal such as a cell phone, a tablet computer, an e-book reader, a multimedia playback device, a wearable device, an in-vehicle terminal, an ipad, a smart TV, etc.

Referring to FIG. 13, the electronic device 1300 may include one or more of the following components: a processing component 1302, a memory 1304, a power supply component 1306, a multimedia component 1308, an audio component 1310, an input/output (I/O) interface 1312, a sensor component 1316, and a communication component 1318.

The processing component 1302 generally controls an overall operation of the electronic device 1300, such as operations associated with display, a telephone call, data communication, a camera operation, and a recording operation. The processing component 1302 may include one or more processors 1320 to execute instructions to complete all or part of the steps of the above method for establishing the user plane connection. In addition, the processing component 1302 may include one or more modules to facilitate interaction between the processing component 1302 and other components. For example, the processing component 1302 may include a multimedia module to facilitate interaction between the multimedia component 1308 and the processing component 1302. For another example, the processing component 1302 may read executable instructions from the memory to implement the steps of the method for establishing the user plane connection provided by the above embodiments.

The memory 1304 is configured to store various types of data to support operations on the electronic device 1300. Examples of these data include instructions for any application or method operated on the electronic device 1300, contact data, phonebook data, messages, pictures, videos, etc. The memory 1304 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 1306 provides power for various components of the electronic device 1300. The power supply component 1306 may include a power management system, one or more power supplies, and other components associated with generating, managing and distributing power for the electronic device 1300.

The multimedia component 1308 includes a display screen providing an output interface between the electronic device 1300 and a user. In some embodiments, the multimedia component 1308 includes at least one of a front camera or a rear camera. When the electronic device 1300 is in an operation mode, such as a shooting mode or a video mode, at least one of the front camera or the rear camera may receive external multimedia data. Each front camera and rear camera may be a fixed optical lens system, or may have a focal length and an optical zoom capability.

The audio component 1310 is configured to output and/or input audio signals. For example, the audio component 1310 includes a microphone (MIC) configured to receive an external audio signal when the electronic device 1300 is in the operation mode, such as a call mode, a recording mode, and a speech recognition mode. The received audio signal may be further stored in the memory 1304 or transmitted via the communication component 1318. In some embodiments, the audio component 1310 further includes a speaker for outputting an audio signal.

The I/O interface 1312 provides an interface between the processing component 1302 and a peripheral interface module. The peripheral interface module may be a keyboard, a click wheel, a button, etc. These buttons may include, but are not limited to: a home button, a volume button, a start button, and a lock button.

The sensor component 1316 includes one or more sensors for providing state evaluation of various aspects to the electronic device 1300. For example, the sensor component 1316 may detect an on/off state of the electronic device 1300, and relative positioning of components, such as the components being a display and a keypad of the electronic device 1300. The sensor component 1316 may further detect a change in the position of the electronic device 1300 or a component of the electronic device 1300, the presence or absence of contact of the user with the electronic device 1300, the orientation or acceleration/deceleration of the electronic device 1300, and a temperature change of the electronic device 1300. The sensor component 1316 may include a proximity sensor configured to detect the presence of nearby objects without any physical contact. The sensor component 1316 may further include an optical sensor, such as a CMOS or CCD image sensor, for use in imaging applications. In some embodiments, the sensor component 1316 may further include an acceleration sensor, a gyroscope sensor, a magnetic sensor, a pressure sensor, or a temperature sensor.

The communication component 1318 is configured to facilitate wired or wireless communication between the electronic device 1300 and other devices. The electronic device 1300 may access a wireless network based on a communication standard, such as Wi-Fi, 2G, 3G, 4G, 5G, or a combination thereof. In an example, the communication component 1318 receives a broadcast signal or broadcast-related information from an external broadcast management system via a broadcast channel. In an example, the communication component 1318 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example, the electronic device 1300 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the above method for establishing the user plane connection.

In an example, a non-transitory machine-readable storage medium including instructions is further provided, such as the memory 1304 including instructions. The instructions may be executed by the processor 1320 of the electronic device 1300 to complete the above method for establishing the user plane connection. For example, the non-transitory computer-readable storage medium may be a ROM, a random access memory (RAM), a CD-ROM, a magnetic tape, a floppy disk, an optical data storage device, etc.

Other implementation schemes of the present disclosure are apparent to those skilled in the art after consideration of the specification and practice of the invention disclosed here. The present disclosure is intended to cover any variations, uses, or adaptations of the present disclosure that follow the general principles of the present disclosure and include common knowledge or customary technical means in the technical field not disclosed in the present disclosure. The specification and embodiments are considered as examples merely, and the true scope and spirit of the present disclosure are indicated by the following claims.

It is to be understood that the present disclosure is not limited to the exact structure that has been described above and illustrated in the accompanying drawings, and that various modifications and changes may be made without departing from its scope. The scope of the present disclosure is merely limited by the appended claims.

1. A method for establishing a user plane connection, performed by an access and mobility management function (AMF), the method comprising:
determining a target location management function (LMF) for user plane positioning in response to determining that a first device triggers reselection of an LMF, wherein the first device comprises at least one of a terminal, the AMF, a source LMF, or a session management function (SMF); and
sending information on the target LMF to the SMF, wherein the information on the target LMF is configured to instruct the SMF to establish a user plane connection between the terminal and the target LMF.

2. The method according to claim 1, wherein in a case where the first device comprises the terminal, determining that the first device triggers the reselection of the LMF comprises:
determining, in response to receiving a first message sent by the terminal, that the terminal triggers the reselection of the LMF, wherein the first message comprises a reason for re-establishing the user plane connection, or the first message indicates the reason for re-establishing the user plane connection;
wherein the first message comprises any one of the following:
an uplink non-access stratum transport (UL NAS TRANSPORT) message;
a service request message; or
first user plane information, wherein the first user plane information comprises information on the source LMF.

3-4. (canceled)

5. The method according to claim 1, wherein in a case where the first device comprises the SMF, determining that the first device triggers the reselection of the LMF comprises:
determining, in response to receiving a second message sent by the SMF, that the SMF triggers the reselection of the LMF, wherein the second message is configured to indicate a change related to a protocol data unit (PDU) session;
wherein the method further comprises:
subscribing to a PDU session management context status notification service of the SMF before receiving the second message sent by the SMF.

6. (canceled)

7. The method according to claim 1, wherein in a case where the first device comprises the AMF, determining that the first device triggers the reselection of the LMF comprises any one of the following:
determining, in response to determining that a status of the terminal changes, that the AMF triggers the reselection of the LMF;
determining, based on a third message sent by the SMF, that the AMF triggers the reselection of the LMF, wherein the third message comprises at least one of information on a user plane function (UPF) or information related to the LMF; or
determining, based on a fourth message sent by the terminal, that the AMF triggers the reselection of the LMF, wherein the fourth message comprises mobility information on the terminal.

8. The method according to claim 1, further comprising:
sending a fifth message to the SMF, wherein the fifth message is used by the SMF to determine whether to perform user plane function (UPF) relocation;
wherein the fifth message comprises a protocol data unit (PDU) session update request message; or
in a case where the SMF subscribes to a status notification of the LMF, the fifth message comprises a notification message, wherein the notification message is configured to notify the SMF of a status change of the LMF;
wherein the fifth message is configured to notify the SMF of at least one of the following:
a change in an LMF used to establish a user plane connection with the terminal; or
the information on the target LMF.

9-11. (canceled)

12. The method according to claim 1, wherein the information on the target LMF comprises at least one of the following:
an Internet protocol (IP) address of the target LMF;
a fully qualified domain name (FQDN) of the target LMF;
an identifier of the target LMF; or
a service area of the target LMF.

13. The method according to claim 8, further comprising at least one of the following:
triggering an insertion or relocation process of an intermediate session management function (I-SMF) based on the information on the target LMF; or
receiving a response message sent by the SMF after the SMF relocates the UPF.

14. (canceled)

15. The method according to claim 1, wherein the reselection of the LMF comprises:
releasing a user plane connection between the terminal and the source LMF; and
establishing the user plane connection between the terminal and the target LMF.

16. A method for establishing a user plane connection, performed by a session management function (SMF), the method comprising:
receiving information on a target location management function (LMF) sent by an access and mobility management function (AMF), wherein the information on the target LMF is sent to the SMF after the AMF determines that a first device triggers reselection of an LMF and the AMF determines the target LMF, and the first device comprises at least one of a terminal, the AMF, a source LMF, or the SMF; and
establishing a user plane connection between the terminal and the target LMF based on the information on the target LMF.

17. The method according to claim 16, further comprising:
sending a second message to the AMF in response to determining that the reselection of the LMF needs to be triggered, wherein the second message is configured to indicate a change related to a protocol data unit (PDU) session;
wherein the method further comprises:
determining that the AMF subscribes to a PDU session management context status notification service of the SMF.

18. (canceled)

19. The method according to claim 16, further comprising:
receiving a fifth message sent by the AMF; and
determining, based on the fifth message, whether user plane function (UPF) relocation needs to be performed;
wherein the fifth message comprises a protocol data unit (PDU) session update request message; or
in a case where the SMF subscribes to a status notification of the LMF, the fifth message comprises a notification message, wherein the notification message is configured to notify the SMF of a status change of the LMF;
wherein the fifth message is configured to notify the SMF of at least one of the following:
a change in an LMF used to establish a user plane connection with the terminal; or
the information on the target LMF.

20-22. (canceled)

23. The method according to claim 16, wherein the information on the target LMF comprises at least one of the following:
an Internet protocol (IP) address of the target LMF;
a fully qualified domain name (FQDN) of the target LMF;
an identifier of the target LMF; or
a service area of the target LMF.

24. The method according to claim 19, further comprising:
determining a relocated UPF in response to determining that the UPF relocation needs to be performed; and
sending a response message to the AMF;
wherein establishing the user plane connection between the terminal and the target LMF based on the information on the target LMF comprises:
establishing, through the relocated UPF, the user plane connection between the terminal and the target LMF based on the information on the target LMF.

25. (canceled)

26. The method according to claim 16, wherein the reselection of the LMF comprises:
releasing a user plane connection between the terminal and the source LMF; and
establishing the user plane connection between the terminal and the target LMF.

27. A method for establishing a user plane connection, performed by a terminal, the method comprising:
sending a first message to an access and mobility management function (AMF) in response to determining that reselection of a location management function (LMF) needs to be triggered, wherein the first message comprises a reason for re-establishing a user plane connection between the terminal and the LMF, or the first message indicates the reason for re-establishing the user plane connection.

28. The method according to claim 27, wherein the first message comprises any one of the following:
an uplink non-access stratum transport (UL NAS TRANSPORT) message;
a service request message; or
first user plane information, wherein the first user plane information comprises information on a source LMF.

29. (canceled)

30. The method according to claim 27, wherein the reselection of the LMF comprises:
releasing a user plane connection between the terminal and a source LMF; and
establishing a user plane connection between the terminal and a target LMF.

31. A device for establishing a user plane connection, applied to an access and mobility management function (AMF), the device comprising:
a processor; and
a memory configured to store processor-executable instructions;
wherein the processor, when executing the processor-executable instructions, is configured to perform the method according to claim 1.

32. A device for establishing a user plane connection, applied to a session management function (SMF), the device comprising:
a processor; and
a memory configured to store processor-executable instructions;
wherein the processor, when executing the processor-executable instructions, is configured to perform the method according to claim 16.

33. A device for establishing a user plane connection, applied to a terminal, comprising:
a processor; and
a memory configured to store processor-executable instructions;
wherein the processor, when executing the processor-executable instructions, is configured to perform the method according to claim 27.

34-36. (canceled)
